(19) United States
(12) Patent Application Publication
(10) Pub. No.: US 2018/0223691 A1
(43) Pub. Date: Aug. 9, 2018

(54) CASE FLANGE WITH STRESS REDUCING FEATURES

(71) Applicant: United Technologies Corporation, Farmington, CT (US)

(72) Inventor: Timothy Dale, Manchester, CT (US)

(21) Appl. No.: 15/423,731

(22) Filed: Feb. 3, 2017

(51) Int. Cl. F01D 25/24; F02K 3/06

(52) U.S. Cl. CPC F01D 25/243; F02K 3/06; F05D 2240/14; F05D 2260/31; F05D 2220/32

(57) ABSTRACT

A gas turbine engine and a flange are disclosed. The gas turbine engine includes a case, and a flange coupled to the case, the flange including a flange body, a fastener hole formed through the flange body, the fastener hole configured to receive a fastener, a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.

### BACKGROUND

The present disclosure relates to flanges for gas turbine engines, and more particularly to flanges with slots and other stress reducing features for gas turbine engines.

Flanges for gas turbine engines can be utilized to attach cases of various engine components. During operation, flanges may experience stresses due to thermal and mechanical loads that may cause cracking and other failure.

Accordingly, it is desirable to provide flanges with stress reducing features.

### BRIEF SUMMARY

According to an embodiment, a flange for use with a case includes a flange body, a fastener hole formed through the flange body, the fastener hole configured to receive a fastener, a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.

In addition to one or more of the features described above, or as an alternative, further embodiments could include that the hoop stress is induced by a thermal gradient.

In addition to one or more of the features described above, or as an alternative, further embodiments could include that the thermal gradient extends radially from an inner edge of the flange body to an outer edge of the flange body.

In addition to one or more of the features described above, or as an alternative, further embodiments could include that the radial slot allows a first thermal expansion of the first portion and a second thermal expansion of the second portion.

In addition to one or more of the features described above, or as an alternative, further embodiments could include that the radial slot allows a first movement of the first portion and a second movement of the second portion.

In addition to one or more of the features described above, or as an alternative, further embodiments could include that the fastener hole receives a flange bolt.

In addition to one or more of the features described above, or as an alternative, further embodiments could include that the fastener hole is a plurality of fastener holes.

In addition to one or more of the features described above, or as an alternative, further embodiments could include that the plurality of fastener holes are circumferentially disposed on the flange body.

In addition to one or more of the features described above, or as an alternative, further embodiments could include that the slot is a plurality of slots corresponding to the plurality of fastener holes.

In addition to one or more of the features described above, or as an alternative, further embodiments could include that the slot extends to an outer edge of the flange body.

In addition to one or more of the features described above, or as an alternative, further embodiments could include that the slot extends to the fastener hole.

In addition to one or more of the features described above, or as an alternative, further embodiments could include a scallop feature disposed on an outer edge of the flange body.

In addition to one or more of the features described above, or as an alternative, further embodiments could include that the flange is attached to the case.

In addition to one or more of the features described above, or as an alternative, further embodiments could include that the flange is configured to be coupled to a second case.

In addition to one or more of the features described above, or as an alternative, further embodiments could include that the flange is configured to be coupled to a second flange.

In addition to one or more of the features described above, or as an alternative, further embodiments could include that the case is at least one of a high pressure turbine case and an outer diffuser case.

According to an embodiment, a case for use with a gas turbine engine includes a case body, and a flange coupled to the case body, the flange including a flange body, a fastener hole formed through the flange body, the fastener hole configured to receive a fastener, a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.

In addition to one or more of the features described above, or as an alternative, further embodiments could include that the hoop stress is induced by a thermal gradient.

In addition to one or more of the features described above, or as an alternative, further embodiments could include that the case is at least one of a high pressure turbine case and an outer diffuser case.

According to an embodiment, a gas turbine engine includes a case, and a flange coupled to the case, the flange including a flange body, a fastener hole formed through the flange body, the fastener hole configured to receive a fastener, a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.

Other aspects, features, and techniques of the embodiments will become more apparent from the following description taken in conjunction with the drawings.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic, partial cross-sectional view of a turbomachine in accordance with this disclosure;

FIG. 2 is a detail view of a flange assembly for use with the turbomachine of FIG. 1;

FIG. 3A is a partial plan view of a flange body for use with the flange assembly of FIGS. 2; and

FIG. 3B is a partial plan view of a flange body for use with the flange assembly of FIG. 2.

### DETAILED DESCRIPTION

Embodiments provide a flange with stress reducing features. The slots of the flange can reduce stress induced by a thermal gradient created during operation to prevent cracking and improve life of the flange.

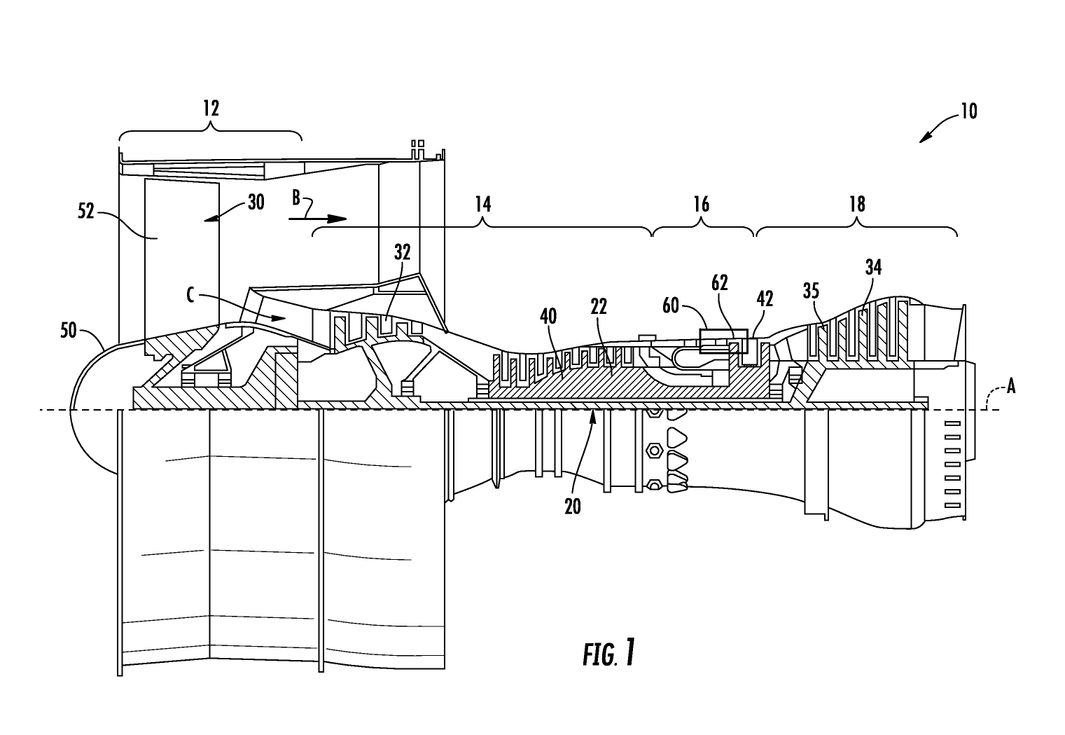

Referring to FIG. 1 a schematic representation of a gas turbine engine 10 is shown. The gas turbine engine includes a fan section 12, a compressor section 14, a combustor section 16, and a turbine section 18 disposed about a longitudinal axis A. The fan section 12 drives air along a bypass flow path B that may bypass the compressor section 14, the combustor section 16, and the turbine section 18. The compressor section 14 draws air in along a core flow path C where air is compressed by the compressor section 14 and is provided to or communicated to the combustor section 16. The compressed air is heated by the combustor section 16 to generate a high pressure exhaust gas stream that expands through the turbine section 18. The turbine section 18 extracts energy from the high pressure exhaust gas stream to drive the fan section 12 and the compressor section 14.

The gas turbine engine 10 further includes a low-speed spool 20 and a high-speed spool 22 that are configured to rotate the fan section 12, the compressor section 14, and the turbine section 18 about the longitudinal axis A. The low-speed spool 20 may connect a fan 30 of the fan section 12 and a low-pressure compressor portion 32 of the compressor section 14 to a low-pressure turbine portion 34 of the turbine section 18. In the illustrated embodiment, the turbine section 18 can include a rotating disc assembly 35. The high-speed spool 22 may connect a high pressure compressor portion 40 of the compressor section 14 and a high pressure turbine portion 42 of the turbine section 18. The fan 30 includes a fan rotor or fan hub 50 that carries a fan blade 52. The fan blade 52 radially extends from the fan hub 50.

In the illustrated embodiment, components of the gas turbine engine 10, including, but not limited to the fan section 12, the compressor section 14, the combustor section 16, and the turbine section 18 can be assembled together with bolted flanges. In certain embodiments, component cases can include flanges to allow connection and assembly thereof. In the illustrated embodiment, flanges 62 are shown in a flange area 60. In the illustrated embodiment, flanges 62 provide a connection between the combustor section 16 and the turbine section 18 of the gas turbine engine 10.

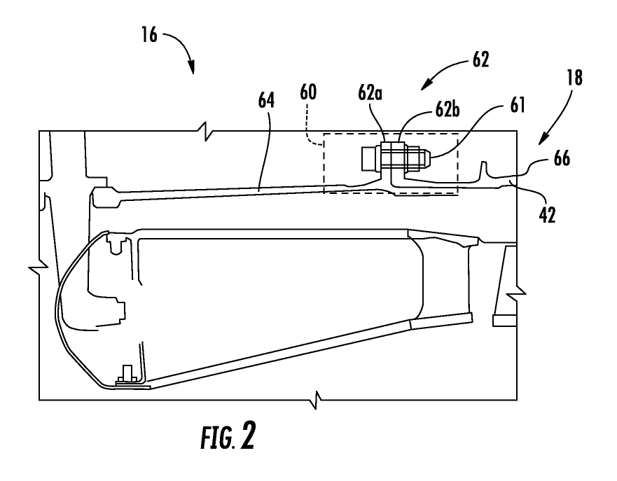

Referring to FIG. 2 a detailed view of the flange area 60 is shown. In the illustrated embodiment, flanges 62 can be utilized to provide mating surfaces to connect a component case to another component. In the illustrated embodiment, flanges 62 include a first flange 62a and a second flange 62b. Flange bolts 61 can be utilized to connect the first flange 62a and the second flange 62b. In the illustrated embodiment, flanges 62 are utilized to assemble an outer diffuser case 64 with the high pressure turbine case 66. During operation, heat can be transferred from the component and component case to the flanges 62 creating a thermal gradient across the flanges 62. In certain applications, the thermal gradient can create thermal stress in certain portions of the flanges 62. In the illustrated embodiment, the flanges 62a, 62b include stress reducing features to minimize thermal stress due to a thermal gradient. The stress reducing features described herein can be utilized for any suitable static flanges.

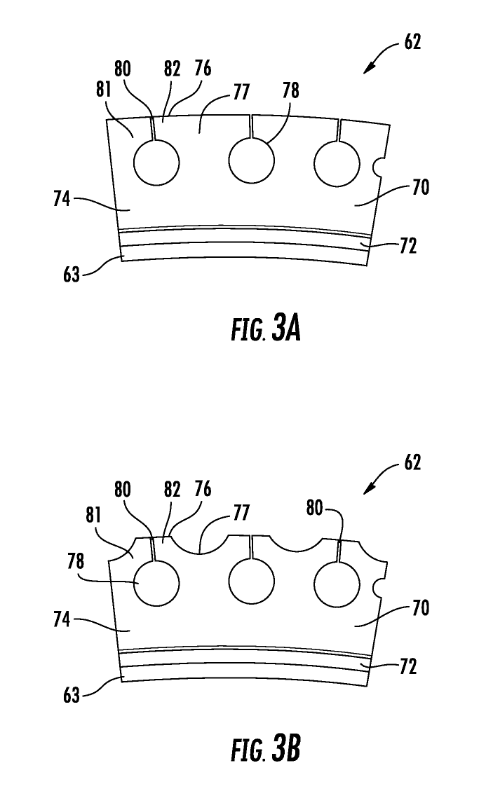

Referring to FIG. 3A, a flange 62 is shown. In the illustrated embodiment, a portion of the flange body 70 is shown. In the illustrated embodiment, the flange 62 includes a flange body 70, an inner portion 74, an outer portion 76, bolt holes 78, and slots 80. In the illustrated embodiment, the slots 80 are stress reducing features that minimize thermal stress introduced by thermal gradients across the flange body 70.

In the illustrated embodiment, the flange body 70 can be formed from any suitable material and thickness. In the illustrated embodiment, the flange body 70 is generally circular or hoop shaped. Bolt holes 78 are formed through the flange body 70. In the illustrated embodiment, a plurality of bolt holes 78 can be utilized to provide a suitable coupling force needed for operation and assembly. The bolt holes 78 can be disposed in a circular arrangement around the flange body 70. In the illustrated embodiment, the flange body 70 is associated with, affixed to, or otherwise coupled to the case body 63. In certain embodiments, the flange body 70 is integrally formed with the case body 63. The case body 63 can be any suitable component case, including, but not limited to the outer diffuser case 64, the high pressure turbine case 66, etc.

In the illustrated embodiment, the flange body 70 includes an inner portion 74 radially disposed adjacent to the case body 63 and an outer portion 76 disposed away from the case body 63. In certain embodiments, the inner portion 74 includes a flange lip 72 that can allow for alignment of the flange body 70 with another flange or any other suitable component.

During operation, heat generating components, such as components in the combustor section 16 or the turbine section 18, etc., can transfer heat into the flange body 70. Due to the proximity of the inner portion 74 of the flange body 70 to heat generating components, the inner portion 74 can heat up more than the outer portion 76, creating a thermal gradient across the flange body 70. In the illustrated embodiment, the thermal gradient extends in a generally radially outward direction, with hotter temperatures near the inner portion 74 and cooler temperatures near the outer portion 76. In certain embodiments, the thermal gradient can be affected by the ambient airflow near the outer portion 76 of the flange body 70.

Due to the thermal gradient experienced across the flange body 70, various portions of the flange body 70 can experience different temperatures at a given time. Due to thermal expansion, various portions of the flange body 70 can expand at different rates in response to the difference in temperatures across the thermal gradient. Therefore, if portions of the flange body 70 are constrained during thermal expansion and contraction, the flange body 70 can experience thermal stress, including, but not limited to increased hoop stress. In the illustrated embodiment, the slots 80 can reduce thermal stress by preventing the buildup and transfer of hoop stress without compromising flange body 70 strength.

In the illustrated embodiment, the slots 80 are radially disposed slots that are formed through the flange body 70. In the illustrated embodiment, the flange body 70 can include a plurality of slots 80 to correspond to the bolt holes 78. The slots 80 can extend to the edge of the outer portion 76. In certain embodiments, the slots 80 can extend into the bolt holes 78.

In the illustrated embodiment, each slot 80 separates a portion of the flange body 70 to define a first portion 81 and a second portion 82 of the flange body 70. Multiple slots 80 can be utilized to define additional portions of the flange body 70. In the illustrated embodiment, the slot 80 allows the first portion 81 and the second portion 82 to not be constrained during thermal expansion and contraction. Therefore, the first portion 81 and the second portion 82 can expand at different rates in response to the experienced thermal gradient to allow for independent movement of the first portion 81 and the second portion 82. Accordingly, by separating the first portion 81 and the second portion 82 hoop stress is not transferred between the first portion 81 and the second portion 82 while maintaining the load carrying capabilities of the flange body 70. Advantageously, the flange body 70 can withstand greater temperature gradients without cracking due to thermal stress.

Referring to FIG. 3B another embodiment of the flange 62 is shown. In the illustrated embodiment, the flange body 70 includes scallop features 77 disposed on the outer portion 76. In certain applications, the scallop features 77 can further reduce thermal stress experienced by the flange body 70 by removing material from high hoop stress areas.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A flange for use with a case, the flange comprising:
a flange body;
a fastener hole formed through the flange body, the fastener hole configured to receive a fastener; and
a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.

2. The flange of claim 1, wherein the hoop stress is induced by a thermal gradient.

3. The flange of claim 2, wherein the thermal gradient extends radially from an inner edge of the flange body to an outer edge of the flange body.

4. The flange of claim 1, wherein the radial slot allows a first thermal expansion of the first portion and a second thermal expansion of the second portion.

5. The flange of claim 1, wherein the radial slot allows a first movement of the first portion and a second movement of the second portion.

6. The flange of claim 1, wherein the fastener hole receives a flange bolt.

7. The flange of claim 1, wherein the fastener hole is a plurality of fastener holes.

8. The flange of claim 7, wherein the plurality of fastener holes are circumferentially disposed on the flange body.

9. The flange of claim 7, wherein the slot is a plurality of slots corresponding to the plurality of fastener holes.

10. The flange of claim 1, wherein the slot extends to an outer edge of the flange body.

11. The flange of claim 1, wherein the slot extends to the fastener hole.

12. The flange of claim 1, further comprising a scallop feature disposed on an outer edge of the flange body.

13. The flange of claim 1, wherein the flange is attached to the case.

14. The flange of claim 1, wherein the flange is configured to be coupled to a second case.

15. The flange of claim 1, wherein the flange is configured to be coupled to a second flange.

16. The flange of claim 1, wherein the case is at least one of a high pressure turbine case and an outer diffuser case.

17. A case for use with a gas turbine engine, the case comprising:
a case body; and
a flange coupled to the case body, the flange comprising:
a flange body;
a fastener hole formed through the flange body, the fastener hole configured to receive a fastener; and
a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.

18. The case of claim 17, wherein the hoop stress is induced by a thermal gradient.

19. The case of claim 17, wherein the case is at least one of a high pressure turbine case and an outer diffuser case.

20. A gas turbine engine, comprising:
a case; and
a flange coupled to the case, the flange comprising:
a flange body;
a fastener hole formed through the flange body, the fastener hole configured to receive a fastener; and
a radial slot formed through the flange body, wherein the radial slot is adjacent to the fastener hole, the radial slot defines a first portion of the flange body and a second portion of the flange body, and the radial slot prevents transfer of a hoop stress between the first portion and the second portion.
